(19) United States
(12) Patent Application Publication
(10) Pub. No.: US 2025/0064267 A1
(43) Pub. Date: Feb. 27, 2025

(54) Filet Table Device

(71) Applicant: William Helms, Coldwater, MS (US)

(72) Inventor: William Helms, Coldwater, MS (US)

(21) Appl. No.: 18/804,560

(22) Filed: Aug. 14, 2024

Related U.S. Application Data
(60) Provisional application No. 63/520,740, filed on Aug. 21, 2023.

(51) Int. Cl. A47J 47/00; A22C 25/06

(52) U.S. Cl. CPC A47J 47/005; A22C 25/06

(57) ABSTRACT

An improved filet table device is disclosed. The device is a table for cleaning fish, cutting meat, or performing other tasks. The filet table device comprises a cutting surface component that is generally configured in a rectangular (i.e., rectilinear) shape. The cutting surface component can be used to clean fish, cut meat, and perform other tasks without damaging the lid of a cooler. The cutting surface component also comprises a support rod that holds the weight of the cutting surface component and assists in the attachment of the filet table device to a cooler. Accordingly, the device provides users with a preparation and cutting surface that can be used anywhere.

### CROSS-REFERENCE TO RELATED APPLICATION

The present application claims priority to, and the benefit of, U.S. Provisional Application No. 63/520,740, which was filed on Aug. 21, 2023, and is incorporated herein by reference in its entirety.

### FIELD OF THE INVENTION

The present invention relates generally to the field of filet table devices. More specifically, the present invention relates to a table for cleaning fish, cutting meat, or performing other tasks. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in filet table devices. Generally, fileting or cleaning fish on top of an expensive cooler is not an ideal option, but it is often the most convenient choice. Additionally, cleaning the top of the cooler afterwards is time consuming and labor intensive. The cutting also puts unnecessary wear and tear on the cooler.

Accordingly, there is a demand for an improved filet table device that provides outdoor enthusiasts with a convenient table for cleaning fish, cutting meat, or performing other tasks.

Therefore, there exists a long felt need in the art for a filet table device that attaches to a cooler to provide an easy to access and easy to clean surface for cutting. There is also a long felt need in the art for a filet table device that makes life easier while on a boat, at the beach, tailgating, or simply relaxing by a river. Further, there is a long felt need in the art for a filet table device that eliminates the need to use the top lid of an expensive cooler as a cutting surface. Finally, there is a long felt need in the art for a filet table device that offers an easy clean up solution after fileting a fish, cutting meat, or performing a variety of other messy tasks.

The subject matter disclosed and claimed herein, in one embodiment thereof, comprises a filet table device. The device is a table for cleaning fish, cutting meat, or performing other tasks. The filet table device comprises a cutting surface component that is generally configured in a rectangular (i.e., rectilinear) shape. The cutting surface component can be used to clean fish, cut meat, and perform other tasks without damaging the lid of a cooler. The cutting surface component also comprises a support rod that holds the weight of the cutting surface component and assists in the attachment of the filet table device to a cooler. Accordingly, the device provides users with a preparation and cutting surface that can be used anywhere.

In this manner, the filet table device of the present invention accomplishes all of the forgoing objectives and provides users with a convenient table for cleaning fish, cutting meat, or performing other tasks. The filet table device attaches to a cooler in use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a filet table device. The device is a table that allows for the cleaning and cutting of fish and other meat. The filet table device comprises a cutting surface component and a support rod that helps secure the cutting surface to the edge of a cooler. Thus, once the device is attached to the edge of a cooler, a user can place fish and meat on the cutting surface and prepare it for cooking.

In one embodiment, the filet table device of the present invention assists any setting in which the preparation of fish or meat for cooking is performed. The filet table device secures easily to the edge of a cooler. The filet table device provides a cleaning and cutting surface for fish and other meat. The filet table device is easily removed from the cooler for cleaning. The device is portable in that it is configured to be easily carried by a person.

In one embodiment, the filet table device comprises a cutting surface component. The cutting surface component is generally configured in a rectangular (i.e., rectilinear) shape but can be configured in any suitable shape as is known in the art. Typically, the body component comprises two opposing generally square corners, and two opposing angled corners. In use, the square corners face the user and the angled corners conform to the angled edges of a cooler.

In one embodiment, the filet table device in accordance with the present invention can be produced in various colors, designs, patterns, etc., and feature logos, emblems and or designs, such as a medical facility requests and/or a user desires.

In one embodiment, the filet table device is manufactured of wood, high-density polyethylene (HDPE), or any other suitable materials as is known in the art. Any number of different types of materials can be used to make the filet table device including but not limited to plastics, nylon, metals, etc.

In one embodiment, fasteners are used to connect the support rod to the cutting surface component. In one embodiment, and when the cutting surface component is comprised of wood, these fasteners are screws. It is to be appreciated that any fasteners that are deemed suitable for the purpose described may be used.

In use, the user secures the cutting surface component to the edge of a cooler via the support rod. The user can then utilize the cutting surface component to clean and cut fish or other meat. When the user is finished, they can easily remove and clean the cutting board component.

It will also be appreciated that there are a number of additional add-on features that can be incorporated into the device and moreover, the filet table device can take many different forms as is known in the art.

In yet another embodiment, the filet table device comprises a plurality of indicia.

In yet another embodiment, a method of conveniently utilizing the device to clean fish, cut meat, or perform other tasks is disclosed. The method includes the steps of providing a filet table device comprising a cutting surface component and a support rod. The method also comprises securing the cutting surface component to a cooler via the support rod. Further, the method comprises cleaning fish or other meat. Additionally, the method comprises cutting fish or other meat on the cutting surface. Next, the method comprises removing the device from the cooler. Further, the method comprises washing the cutting surface of the device. Finally, the method comprises utilizing the device to clean and cut fish and other meat.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the filet table device of the present invention, showing the device attached to a cooler in accordance with the disclosed architecture;

FIG. 2 illustrates a perspective view of one embodiment of the filet table device of the present invention showing fish ready to be fileted on top of the cutting surface component in accordance with the disclosed architecture;

FIG. 3 illustrates a perspective view of one embodiment of the filet table device of the present invention showing a front view of the attachment in accordance with the disclosed architecture;

FIG. 4 illustrates a perspective view of one embodiment of the filet table device of the present invention showing how the device can be easily cleaned in accordance with the disclosed architecture;

FIG. 5 illustrates a perspective view of the underside of one embodiment of the filet table device of the present invention showing the support rod in accordance with the disclosed architecture; and

FIG. 6 illustrates a flowchart showing the method of conveniently utilizing the device to clean fish, cut meat, or perform other tasks in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a filet table device that attaches to a cooler to provide an easy to access and easy to clean surface for cutting. There is also a long felt need in the art for a filet table device that makes life easier while on a boat, at the beach, tailgating, or simply relaxing by a river. Further, there is a long felt need in the art for a filet table device that eliminates the need to use the top lid of an expensive cooler as a cutting surface. Finally, there is a long felt need in the art for a filet table device that offers an easy clean up solution after fileting a fish, cutting meat, or performing a variety of other messy tasks.

The present invention, in one exemplary embodiment, is a novel filet table device for fileting fish, cutting meat, or performing other tasks. The filet table device comprises a cutting surface component that is configured in a generally rectangular (i.e., rectilinear) shape. Fish or other meat can be cleaned, cut, and prepared for cooking on the cutting surface component. The cutting surface component is supported and attached to the edge of a cooler via a support rod. Thus, once the device is attached to the edge of a cooler, a user can cut, clean, and prepare meat or fish for cooking. The present invention also includes a novel method of conveniently utilizing the device to clean fish, cut meat, or perform other tasks. The method includes the steps of providing a filet table device comprising a cutting surface component and a support rod. The method also comprises securing the cutting surface component to a cooler via the support rod. Further, the method comprises cleaning fish or other meat on the cutting surface. Additionally, the method comprises cutting fish or other meat on the cutting surface. Next, the method comprises removing the device from the cooler. Further, the method comprises washing the cutting surface of the device. Finally, the method comprises utilizing the device to clean and cut fish and other meat.

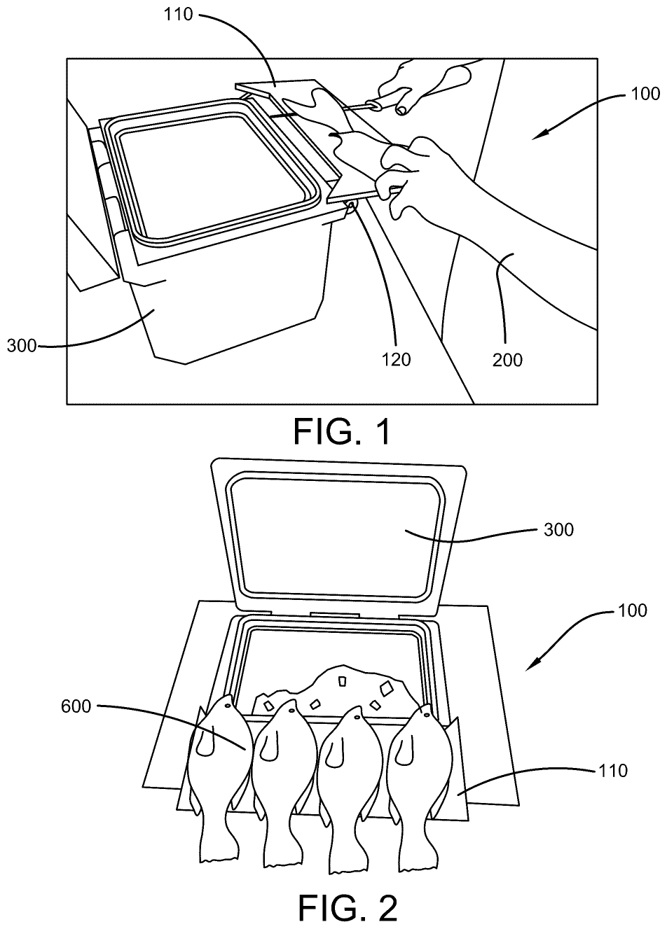

Referring initially to the drawings, FIG. 1 illustrates a perspective view of one embodiment of the filet table device 100 of the present invention, showing the device 100 attached to a cooler 300. In the present embodiment, the filet table device 100 is an improved filet table device 100 that provides outdoor enthusiasts with a convenient table for cleaning fish, cutting meat, or performing other tasks.

Specifically, the filet table device 100 comprises a cutting surface component 110 and a support bar or rod 120. Thus, once the device 100 attached to the edge of a cooler 300, a user 200 can easily clean and cut fish and other meat on the cutting surface 110.

Generally, the filet table device 100 of the present invention assists any setting in which cleaning or cutting of fish or other meat is performed. The filet table device 100 secures easily to the edge of a cooler 300 and provides a hassle-free cleaning and cutting experience. The device 100 is also portable in that it is configured to be easily carried by a person.

As shown in FIG. 2, the filet table device 100 comprises a cutting surface component 110 that can retain a plurality of fish 600. The cutting surface component 110 is typically configured in a rectangular (i.e., rectilinear) shape but can be configured in any suitable shape as is known in the art.

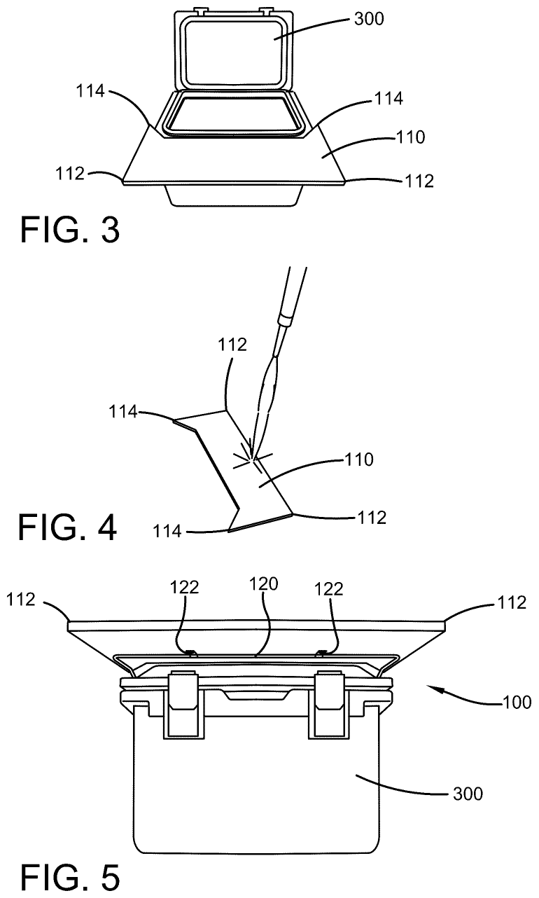

Shown in FIG. 3 is a perspective view of one embodiment of the filet table device 100 of the present invention showing a front view of the attachment. Generally, the cutting board component 110 of the device 100 features two opposing generally square corners 112 and two opposing angled corners 114. In use, the square corners 112 face the user and the angled corners 114 conform to the angled edges of a cooler 300.

FIG. 4 illustrates a perspective view of one embodiment of the filet table device 100 of the present invention showing how the device can be easily cleaned. In this figure, the device 100 is being rinsed down with a hose, although any suitable cleaning methods may be used.

Generally, the cutting surface component 110 and support rod 120 of the device 100 are connected via fasteners 122 in the form of screws, although any suitable fasteners 122 may be used.

As shown in FIG. 5, the cutting surface component 110 of the device 100 is held up by a support rod 120. The support rod 120 is generally U-shaped and serves as a connection between the cutting surface component 110 and a cooler 300. In the present embodiment, the support rod 120 of the device 100 is comprised of metal or plastic, although any material deemed suitable for the purpose described may be used.

The filet table device 100 in accordance with the present invention can be produced in various colors, designs, patterns, etc., and feature logos, emblems and or designs, such as a distributor requests and/or a user 200 desires.

In one embodiment, the filet table device 100 is manufactured of wood, a high-density polyethylene (HDPE), or any other suitable materials as is known in the art. Any number of different types of materials can be used to make the filet table device 100 including but not limited to heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the filet table device 100 is also manufactured from a material that is water resistant or waterproof, or the cutting surface component 110 comprises a coating that is water resistant or waterproof.

In yet another embodiment, the filet table device 100 comprises a plurality of indicia 400. The cutting surface component 110 of the device 100 may include advertising, a trademark, or other letters, designs, or characters, printed, painted, stamped, or integrated into the cutting surface component 110, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be fishing, fileting, or brand related.

It will also be appreciated that there are a number of additional add-on features that can be incorporated into the device 100 and moreover, the filet table device 100 can take many different forms as is known in the art.

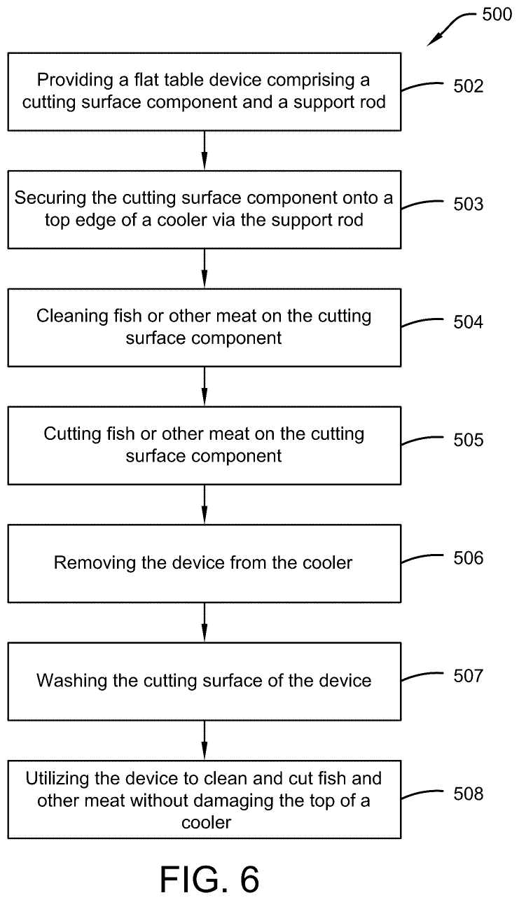

FIG. 6 illustrates a flowchart of the method 500 of conveniently utilizing the device to clean fish, cut meat, or perform other tasks. The method includes the steps of at 501, providing a filet table device comprising a cutting surface component and a support rod. The method also comprises at 502, securing the cutting surface component to a cooler via the support rod. Further, the method comprises at 503, cleaning fish or other meat on the cutting surface. Additionally, the method comprises at 504, cutting fish or other meat on the cutting surface. Next, the method comprises at 505, removing the device from the cooler. Further, the method comprises at 506, washing the cutting surface of the device. Finally, the method comprises at 507, utilizing the device to clean and cut fish and other meat without damaging the top of a cooler.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “filet table device”, “table device”, and “device” are interchangeable and refer to the filet table device 100 of the present invention.

Not withstanding the forgoing, the filet table device 100 of the present invention can be of any suitable size and configuration as is known in the art without affecting the overall concept of the invention, provided that it accomplishes the above stated objectives. One of ordinary skill in the art will appreciate that the filet table device 100 as shown in FIGS. 1-5 is for illustrative purposes only, and that many other sizes and shapes of the filet table device 100 are well within the scope of the present disclosure. Although the dimensions of the filet table device 100 are important design parameters for user convenience, the filet table device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A filet table device comprising:
a cutting board having a cutting surface;
a support bar; and
a plurality of fasteners;
wherein said cutting surface is rectilinear;
wherein said cutting board having two opposing square corners and two opposing angled corners;
wherein said two opposing square corners face a user and said two opposing angled corners conform to angled edges of a cooler; and
further wherein said support bar selectively attachable with said plurality of fasteners to a top edge of a cooler.

2. The filet table device of claim 1, wherein said cutting board and said support bar selectively removable from the cooler for portability.

3. The filet table device of claim 2, wherein said plurality of fasteners are a plurality of screws for securing said support bar to the top edge of the cooler.

4. The filet table device of claim 3, wherein said support bar is U-shaped extending to an underside of said cutting board for securing said cutting board in front of the cooler.

5. The filet table device of claim 4, wherein said support bar having a material selected from the group consisting of a metal and a plastic.

6. The filet table device of claim 5, wherein said cutting board having a material selected from the group consisting of a high-density polyethylene.

7. The filet table device of claim 5, wherein said cutting board having a material selected from the group consisting of a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene.

8. The filet table device of claim 7, wherein said cutting surface having a waterproof coating.

9. A filet table device comprising:
a cutting board having a cutting surface;
a support bar; and
a plurality of fasteners;
wherein said cutting surface is rectilinear;
wherein said cutting board having two opposing angled corners;
wherein said two opposing angled corners conform to angled edges of a cooler; and
further wherein said support bar selectively attachable with said plurality of fasteners to a top edge of the cooler.

10. The filet table device of claim 9, wherein said cutting board having two opposing square corners, and further wherein said two opposing square corners face a user.

11. The filet table device of claim 10, wherein said cutting board and said support bar selectively removable from the cooler for portability.

12. The filet table device of claim 11, wherein said plurality of fasteners are a plurality of screws for securing said support bar to the top edge of the cooler.

13. The filet table device of claim 12, wherein said support bar is U-shaped extending to an underside of said cutting board for securing said cutting board in front of the cooler.

14. The filet table device of claim 13, wherein said support bar having a material selected from the group consisting of a metal and a plastic.

15. The filet table device of claim 13, wherein said cutting board having a material selected from the group consisting of a high-density polyethylene.

16. The filet table device of claim 13, wherein said cutting board having a material selected from the group consisting of a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene.

17. The filet table device of claim 16, wherein said cutting surface having a waterproof coating.

18. A method of using a filet table device with a cooler, the method comprising the steps of:
providing a cutting board having a cutting surface, a support bar, and a plurality of fasteners, wherein said cutting surface is rectilinear, wherein said plurality of fasteners are a plurality of screws for securing said support bar to a front edge of a cooler, and further wherein said cutting board having two opposing angled corners;
conforming said two opposing angled corners to angled edges of the cooler; and
selectively attaching said support bar with said plurality of fasteners to a top edge of the cooler.

19. The method of using a filet table device with a cooler of claim 18, wherein said support bar is U-shaped extending to an underside of said cutting board for securing said cutting board in front of the cooler, and further wherein said cutting board and said support bar selectively removable from the cooler for portability.

20. The method of using a filet table device with a cooler of claim 19, wherein said cutting board having a material selected from the group consisting of a heat-sealable polymer, a polypropylene, an acrylonitrile-butadiene-styrene (ABS), an acrylic, a polycarbonate, a polyethylene, a polyethylene terephthalate, a polyvinyl chloride, and a polystyrene, and further wherein said cutting surface having a waterproof coating.
